(19) United States
(12) Patent Application Publication
(10) Pub. No.: US 2008/0214094 A1
(43) Pub. Date: Sep. 4, 2008

(54) METHOD FOR MANUFACTURING SILICON WAFER

(76) Inventors: Takeo KATOH, Tokyo (JP); Yasuyuki Hashimoto, Tokyo (JP); Kazushige Takaishi, Tokyo (JP); Tomohiro Hashii, Tokyo (JP); Katsuhiko Murayama, Tokyo (JP); Sakae Koyata, Tokyo (JP)

Correspondence Address: DUANE MORRIS LLP;PATENT DEPARTMENT, 1540 BROADWAY, NEW YORK, NY, 10036-4086, US

(21) Appl. No.: 12/031,917

(22) Filed: Feb. 15, 2008

(30) Foreign Application Priority Data
Feb. 15, 2007 (JP) JP2007-034572

(51) Int. Cl. B24B 7/24; B28D 1/02; B24B 7/26; B24B 9/08

(52) U.S. Cl. 451/41; 125/20; 451/44; 451/60

(57) ABSTRACT

A method for manufacturing a silicon wafer comprises a slicing step of a silicon single crystal ingot to obtain sliced wafers, a single-side grinding step to grind only one side of a wafer, and a smoothing step to smooth the other side of the wafer by controlling application of etchant depending on surface profile of the other side of the wafer. According to a method of the present invention a silicon wafer that has high flatness, is removed machine working damage, and is reduced of profile change of chamfer to be minimal can be manufactured.

### BACKGROUND OF THE INVENTION

1. Field of the Invention

The present invention relates to a method for manufacturing a silicon wafer.

2. Description of the Related Art

In the prior art for manufacturing silicon wafer, as an example shown in FIG. 10, the top and the end part of a grown silicon single crystal ingot are cut to make a block, the outer surface of the block is ground to make the diameter of the ingot uniform, an orientation flat and/or an orientation notch are made to the block in order to indicate a specific crystal orientation, and then the block is sliced at a predetermined angle to the rod axis direction (Step 1). A sliced wafer is chamfered in order to prevent peripheral part of the wafer from cracking or chipping (Step 2). Then both front side and backside of the silicon wafer are simultaneously ground as flattening step (Step 3). Further, each of front side and backside of the wafer is independently ground (Step 4a and 4b). Next, both front side and backside of the wafer are simultaneously polished (Step 5). And then the front side of the wafer is polished (Step 6). Hereby a desired silicon wafer is obtained (see Patent Document 1, for example).

Patent Document 1

Japanese Examined Patent Application Publication No. 3664593 (FIG. 11)

In the said prior art of manufacturing process, however, on the one hand it is relatively easy to implement accuracy of shape, on the other hand damage by working remains on the wafer because machine working is applied on both front and backside of the wafer.

Also, dip etching, which is used as a step in conventional manufacturing process is useful to remove machine working damage, but has disadvantage of difficulty to keep accuracy of shape. Single disk wafer spin etching is effective to remove machine working damage because it is fully chemical working and is also possible to keep accuracy of shape thanks to high flexibility of recipe setting. Single disk wafer spin etching is, however, in principle “quantitative working” process and therefore in case that thickness of input material disperses another art such as reflecting premeasured value of the thickness to working recipe is needed to get uniform thickness after process. In addition to that it is difficult in working by single disk wafer spin etching to avoid profile change of chamfered part depending on removal amount.

### SUMMARY OF THE INVENTION

The invention is intended to provide a method manufacturing silicon wafer with high flatness, removing machine working damage and controlling change of profile of chamfer to be minimal.

A first aspect of the present invention is a manufacturing method of manufacturing silicon wafer comprising, as shown in FIG. 1, step 11 to get sliced wafer by slicing silicon single crystal ingot, step 14 grinding only one side of the wafer, and smoothing step 15 to smooth the other side of the wafer by controlling application of etchant depending on the surface status of the other side of wafer.

According to the first aspect of the present invention, sizing work is performed to one side of a sliced wafer at single-side grinding step 14, while machine working damage of the other side of wafer is removed at smoothing step 15. When single-side grinding step 14 and smoothing step 15 are combined for wafer working, at single-side grinding step 14 flatness of a wafer is kept in excellent accuracy of shape, and in spite of different thickness of input material the thickness of the input material can be controlled uniform. At smoothing step 15 machine working damage on the other side of the wafer is effectively removed and accuracy of shape may be maintained thanks to high flexibility of recipe setting. Also by combining single-side grinding step 14 and smoothing step 15, profile change of chamfer of the wafer induced by working at chamfering step 12 can be controlled to be minimal.

A second aspect of the present invention relates to the first aspect and is a manufacturing method comprising a single-side grinding step and a smoothing step performed in this order.

A third aspect of the present invention relates to the first aspect and is a manufacturing method comprising smoothing step and single-side grinding performed in this order.

A fourth aspect of the present invention relates to any one of the first through the third aspect and is a manufacturing method further comprising a step to chamfer periphery of one side and the other side of the wafer before the single-side grinding step or smoothing step.

A fifth aspect of the present invention relates to any one of the first though the third aspect and is a manufacturing method further comprising a double-side grinding step to grind one side and the other side of the wafer simultaneously before the single-side grinding step and smoothing step.

A sixth aspect of the present invention relates to any one of the first through the third aspect and is a manufacturing method further comprising a step to lap one side and the other side of the wafer simultaneously before the single-side grinding step and smoothing step.

A seventh aspect of the present invention relates to the first aspect and is a manufacturing method further comprising a step to polish one side and the other side of the wafer simultaneously after the single-side grinding step or smoothing step.

A eighth aspect of the present invention relates to the second aspect and is a manufacturing method further comprising a step to polish one side and the other side of the wafer simultaneously after the smoothing step.

A ninth aspect of the present invention relates to the third aspect and is a manufacturing method further comprising a step to polish one side and the other side of the wafer simultaneously after the single-side grinding step.

A tenth aspect of the present invention relates to any one of the seventh through the ninth aspect and is a manufacturing method wherein at the step to grind one side and the other side of the wafer simultaneously the total removal amount of both sides is less then 12 μm.

A eleventh aspect of the present invention relates to any one of the seventh through the ninth aspect and is a manufacturing method further comprising a step to polish the other side of the wafer after the step to polish one side and the other side of the wafer simultaneously.

A twelfth aspect of the present invention relates to any one of the first through the eleventh aspect and is a manufacturing method wherein one side of a wafer is the backside of the wafer and the other side of the wafer is the front side of the wafer.

According to a manufacturing method of silicon wafer of the present invention, sizing work is performed on one side of a sliced wafer at a single-side grinding step, and machine working damage on the other side of the wafer can be removed at a smoothing step by etching. When a single-side grinding step and a smoothing step are combined for wafer working, flatness of a wafer can be maintained to high accuracy of shape at the single-grinding step and in spite of dispersion of thickness of input material it can be made uniform at the single-side grinding step. At the smoothing step machine working damage on the other side of the wafer is effectively removed and the accuracy of shape can be maintained thanks to high flexibility of recipe setting. Thus by combining a single-side grinding step and a smoothing step, shape change of chamfer of the wafer at these steps may be controlled to be minimal.

### BRIEF DESCRIPTION OF THE DRAWINGS

FIG. 1 is a flowchart showing a method for manufacturing silicon wafer according to an embodiment or the present invention;

FIG. 2 is a flowchart showing a method for manufacturing silicon wafer according to another embodiment of the present invention;

FIG. 3 is a top view of a single-side grinding device;

FIG. 4 is a longitudinal sectional view of a single-side grinding device;

FIG. 5 is a schematic of a single disk wafer etching device;

FIG. 6 is a plot showing relationship between total removal amount of both sides at double-side grinding step and LPD (Light Point Defect) counts in the Example 1 and Comparative Example 1;

FIG. 7 (a) is a view of profile of chamfer in Example 2,
(b) is a view of profile of chamfer in Comparative Example 2,
(c) is a view of profile of chamfer in Comparative Example 3;

FIG. 8 is a plot showing dimension of BC of chamfer in Example 2 and comparative examples 2 and 3;

FIG. 9 is a plot showing SFRQ in Example 2 and Comparative Examples 2 and 3; and

FIG. 10 is a flowchart of a conventional method for manufacturing silicon wafer.

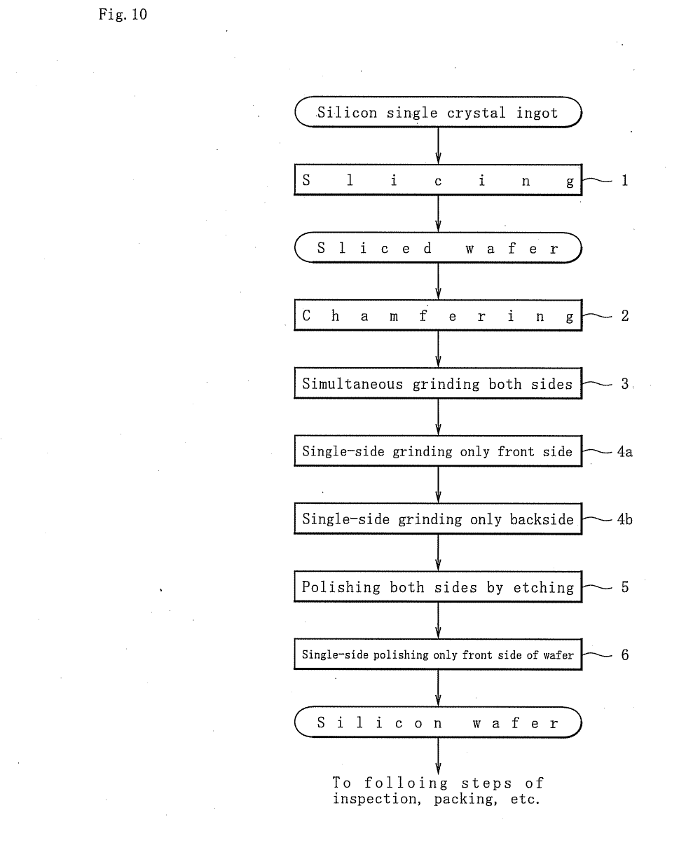

### DETAILED DESCRIPTION OF THE PREFERRED EMBODIMENTS

Preferred embodiments according to the present invention are described in more details in reference to the attached drawings hereinafter.

A grown silicon single crystal ingot is firstly inspected with its resistivity and crystallinity, then is cut off the top and end part and is cut into blocks having a certain range of resistivity. Periphery of each block is ground to make diameter of blocks uniform because an ingot as grown is not a perfect cylinder and its diameter is not uniform. An orientation flat or an orientation notch to indicate a specific crystal orientation is made to the block whose peripheries have been ground.

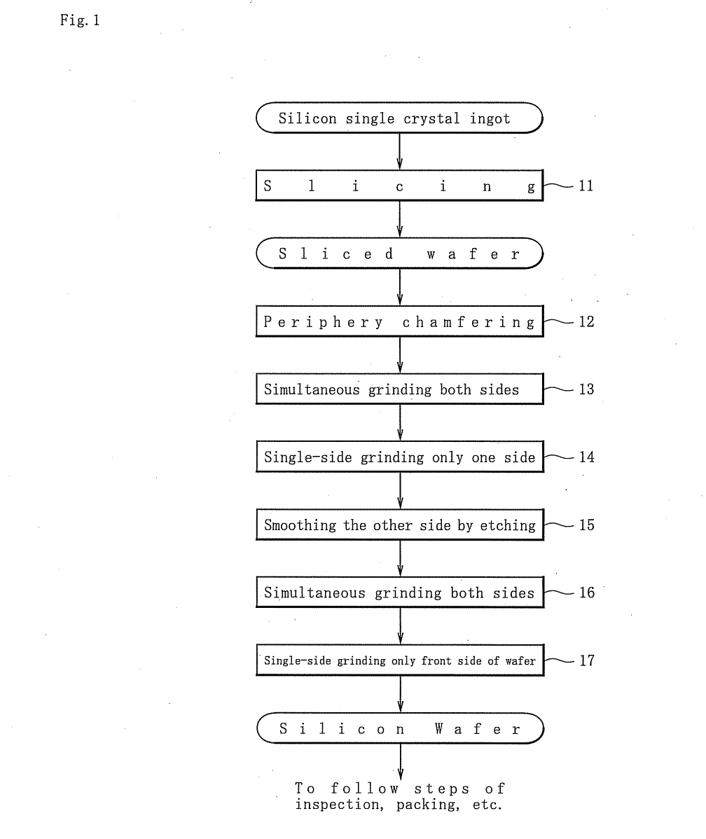

Following this process, each block is sliced at a predetermined angle to the rod axis direction as shown in FIG. 1 (Step 11).

A sliced wafer is chamfered at the periphery of one side and the other side of the wafer in order to prevent peripheral part of the wafer from cracking or chipping (Step 12). By chamfering both sides of periphery of the wafer at step 12, crown phenomenon where the periphery rises circularly at epitaxial growth on the surface of a non-chamfered silicon wafer due to abnormal growth can be prevented. Chamfering Step 12 is preferably performed before single-side grinding step or smoothing step. In case that the removal amount for one side at the following grinding step is different from the removal amount for the other side at the smoothing step, it is preferable to make periphery profile of one side of wafer asymmetrical to the other side, considering the removal amount at the single-side grinding step and the removal amount at the smoothing step, so that the periphery profile of one side after single-side grinding step is nearly symmetrical to the periphery profile of the other side after smoothing step.

Then one side and the other side of a silicon wafer are simultaneously ground (Step 13). This step 13 may be performed either before or after a chamfering step, so far as it is performed before a single-side grinding step and a smoothing step. Instead of this double-side grinding, both sides of a wafer may be lapped simultaneously. This double-side grinding or lapping flattens irregularity of both sides of the wafer produced at slicing step and the like, to improve flatness and parallelism of the wafer.

Damaged layer, namely deteriorated layer by working is formed on the silicon wafer during machine working steps up to step 13. This deteriorated layer by working is needed to be fully removed because it may induce lattice defect like slip dislocation in device production process, or reduce mechanical strength of a wafer and also deteriorate electrical characteristics.

A method for manufacturing silicon wafer of the present invention comprises step 14 wherein only one side of a wafer is ground, and smoothing step 15 wherein the other side of the wafer is smoothed under control of application of etchant depending on the shape of the surface of the other side.

Sizing work is performed on one side of a wafer at single-side grinding step 14. At this single-side grinding step 14 the flatness and high accuracy of shape of the wafer can be maintained. Also the thickness of input material can be controlled to be uniform at single-side grinding step 14 in spite of dispersion of thickness of input material. Working damage on the other side of the wafer can be removed at smoothing step 15. At smoothing step 15 machine working damage on the other side of the wafer can be effectively removed and accuracy of shape may be maintained thanks to high flexibility of recipe setting. Thus by combining single-side grinding step 14 and smoothing step 15, change of chamfer caused at chamfering step 12 of wafer can be reduced to be minimal.

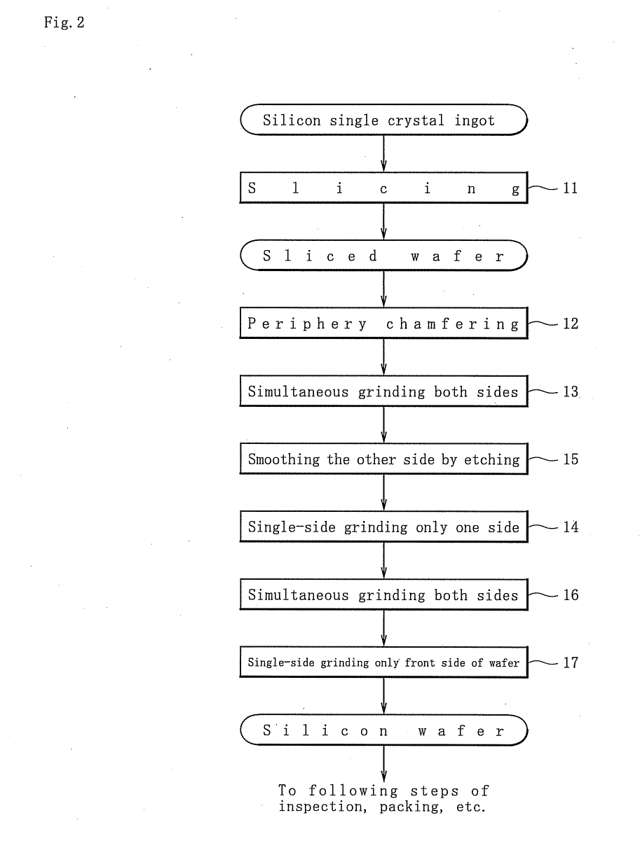

Single-side grinding step 14 and smoothing step 15 in a manufacturing method of the present invention may be performed either in the order of single-side grinding step 14 first and then smoothing step 15 as shown in FIG. 1, or smoothing step 15 first and then single-side grinding step 14 as shown in FIG. 2.

Step 14 of single-side grinding of a wafer will be described more in detail.

At this single-side grinding step 14, irregular layer on one side of a wafer is flattened by grinding to improve flatness and parallelism of that side of the wafer. Also deteriorated layer introduced by machine working like block cutting, peripheral grinding or slicing step 11 is mostly removed.

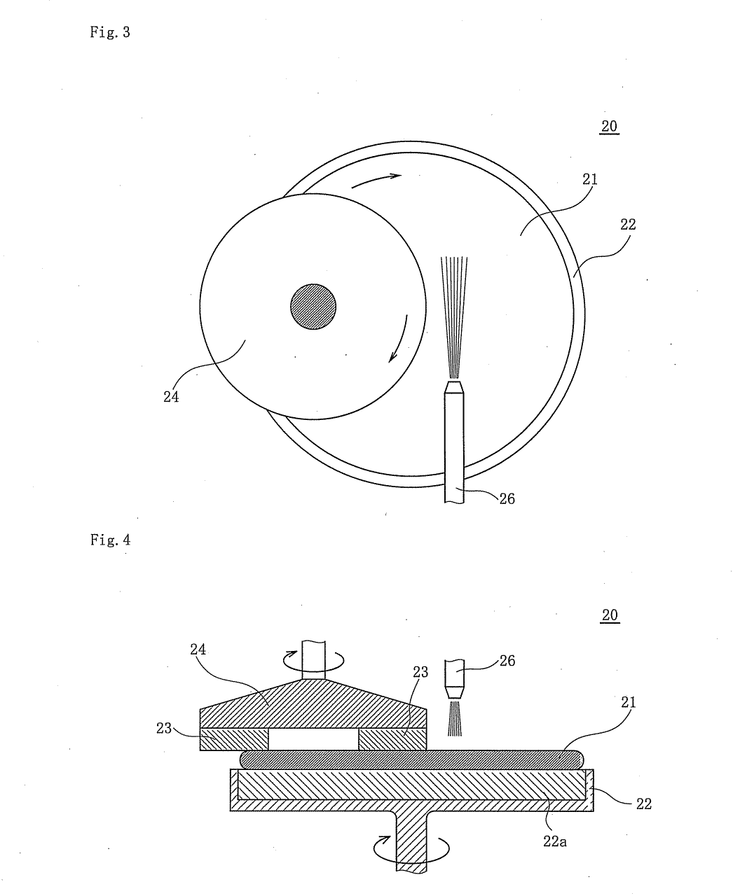

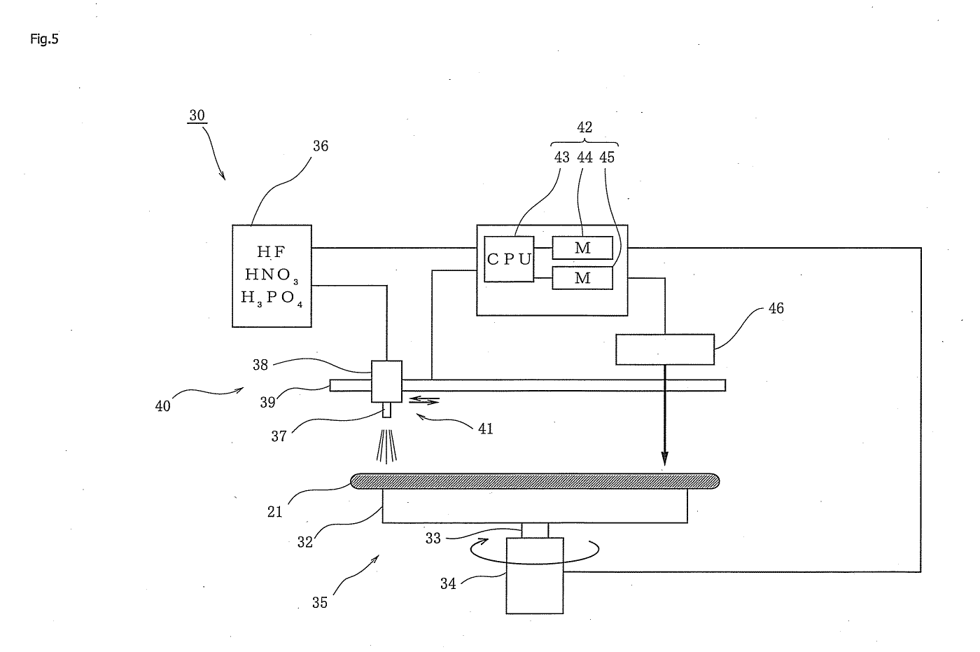

Step 14 is preferably performed using single-side grinding device 20 shown in FIG. 3 and FIG. 4. As shown in FIG. 3, a turntable 22 to mount a wafer 21 as an in-process body support is arranged to rotate around the vertical axis by driving mechanism (not shown). As shown in FIG. 4, a grinding disk support 24 is arranged to support grinding disk 23 for pressing its grinding surface on wafer 21 which is mounted by suction on turntable 22 via chuck 22a. Grinding disk support 24 is configured to rotate grinding disk 23 around the vertical axis by driving mechanism (not shown). Water supply nozzle 26 is arranged above the wafer to supply water to the surface of the wafer 21 on the occasion of grinding.

In such single-side grinding device 20 wafer 21 is mounted by suction onto turntable 22 directing one side of the wafer upwards, grinding disk 23 and wafer 21 are relatively rotated by their own driving mechanism, grinding water is supplied by water supply nozzle 26 to a different part of one side of the wafer than the contact part with grinding disk 23, and grinding disk 23 is pressed onto that side of wafer 21 to grind while rinsing water is poured on that side of wafer 21.

The wafer whose flatness and parallelism have been improved at step 14 is rinsed at rinsing step and then transferred to the next step.

Now smoothing step 15 to smooth the other side of the wafer by controlling application of etchant depending on the surface shape of the other side of the wafer will be explained.

At smoothing step 15 irregular layer of the other side of the wafer created at slicing step and the like is flattened to improve flatness and parallelism of the other side of the wafer. Deteriorated layer introduced by working to the other side of the wafer in the process of block cutting, peripheral grinding and slicing step 11 will be fully removed. Surface roughness of the wafer is also controlled by using acid etchant as etchant for smoothing.

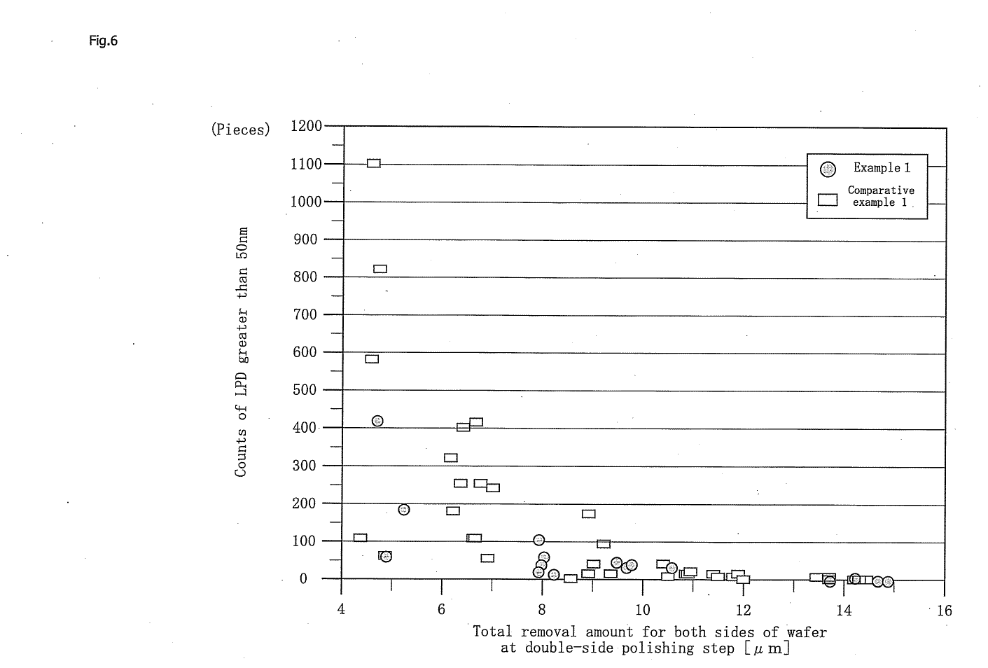

At smoothing step 15 etching device 30 as shown in FIG. 5 will be used.

Single disk wafer etching device 30 shown in FIG. 5 comprises stage 32 which supports wafer 21 and driving source for rotation 34 like motor which is coupled to and rotates stage 32 via rotation axis 33, and all these configure wafer rotation unit 35.

Single disk wafer etching device 30 also includes supply unit of etchant 36 which supplies etchant, nozzle 37 which is supplied with etchant by supply unit of etchant 36 and jets out the etchant to the other side of wafer 21, nozzle base 38 to support nozzle 37 as movable and guide 39 which controls position and movement of nozzle base 38, and all these configure control unit of nozzle position 40. Nozzle base 38 comprises an adjusting mechanism of angle of nozzle 37 relative to nozzle base 38, an adjusting mechanism of the height position of the tip of nozzle 37 from wafer 21, a jetting on-off mechanism of etchant from nozzle 37, and all these configure jetting status control unit 41.

Single disk wafer etching device 30 further comprises control unit 42 which regulates speed of rotation driving source 34 to determine rotation speed of a wafer, regulates etchant supply unit 36 to control supply status of etchant, and regulates nozzle position control unit 40 and jetting status control unit 41 to control status and position of nozzle 37. Control unit 42 comprises arithmetic unit 43 like CPU and a plurality of memory 44, 45 and so on. Reference number 46 indicates a surface status detection device for the other side of the wafer, which measures irregularity of the other side of the wafer by laser beam reflection technique utilizing beam reflection from the other side of the wafer. Detection unit 46 may be installed as a stand-alone device, not included in single disk wafer etching device 30, to measure irregularity of the other side of the wafer.

Etchant supply unit 36 supplies nozzle 37 with acid etchant. Etchant supply unit 36 may firstly prepare acid etchant by mixing acid to predetermined mixture ratio and then supply it to nozzle 37, or may supply each component separately to nozzle 37 to mix each component in the vicinity of nozzle 37.

In nozzle position control unit 40 guide 39, which regulates movement of nozzle base 38, extends across the rotation center and supports nozzle 38 to make nozzle 37 movable in radial direction of wafer 21. Guide 39 is so configured that nozzle 38 can move in the length direction of the guide. The position of nozzle 37 relative to the rotation center of wafer 21 can be set by moving position of nozzle base 38 in the length direction of guide 39. Nozzle base 38 is equipped with moving mechanism in length direction of guide 39.

Guide 39 may be also configured that its one end is placed above the rotation center of wafer 21 and is supported to make its another end swing in the horizontal plane so that guide 39 can swing in the horizontal plane to make traveling nozzle 37 move in the plane parallel to wafer 21.

Jetting status control unit 41 is installed in nozzle base 38 and comprises an angle adjusting unit to adjust angle of nozzle 37 to nozzle base 38, a height adjusting unit to adjust height position of the tip of nozzle 37 from wafer 21, and a valve body to switch jetting on-off of etchant from nozzle 37. It is also possible to switch the supply from etchant supply unit 36 without using a valve body.

Control unit 42 comprises at least memories 44, 45 and so on to store irregularity of the other side of wafer 21 before processing, position of nozzle 37 and etching status, jetting rate of etchant and etching status, and surface shape of the other side of wafer 21 which will be baseline after processing, and also comprises arithmetic unit 43 to calculate movement of nozzle 37 and jetting status of etchant by using these data. Memories 44, 45 and so on store data of surface status of the other side of wafer 21 before processing detected by detector unit 46. These stored data can be those of surface status detected by detector unit and stored for every processed wafer, or those of surface status detected by surface detection unit and stored for a representative wafer every certain numbers of wafer, or those detected for projected part of a certain wafer every ingot, or those predetermined data for the type of wafer.

For performing smoothing step 15 with the other side of the wafer 21 using single disk wafer etching device 30 according to an embodiment of the present invention, surface irregularity in a plurality of areas of the other side of wafer 21 are measured using detector unit 46 and then these data are input to shape control unit 42 for wafer 21 to store in memories 44, 45 and so on.

Next, the other side of wafer 21 is supported on stage 32 placing the other side of wafer 21 upward, and the stage 32 is rotated by rotation driving source 34 under control by control unit 42.

Further etchant containing predetermined composition from etchant supply unit 36 is supplied to nozzle 37 via control unit 42, and the etchant is jetted out to the other side of wafer 21 under control of status and position of nozzle 37 as well as jetting time by nozzle position control unit 40 and jetting status control unit 41.

Horizontal movement of nozzle 37 is mostly made in speed of 0.1 to 20 mm/s, and either on a guide, which is pivoted at its end and swings, from the center of the wafer towards periphery of the wafer, or in a reciprocating motion between the center of the wafer and periphery of the wafer in radial direction. Etchant supplied to the other side of wafer 21 gradually moves from the center area of the wafer to the peripheral area due to centrifugal force by rotation of the wafer, etching the deteriorated layer by working of the wafer, and finally spilled out as droplet from the periphery of the wafer.

Etchant used at smoothing step 15 is preferably aqueous solution containing hydrofluoric acid, nitric acid and phosphoric acid. Mixture ratio of hydrofluoric acid, nitric acid and phosphoric acid in the aqueous solution in percentage by weight is preferably hydrofluoric acid:nitric acid:phosphoric acid=0.5-40%:5-50%:5-70%. The aforementioned mixture ratio is suitable for improving flatness and parallelism of the other side of wafer because it will give viscosity of 2-40 mPa·sec and surface tension of 50-70 dyne/cm to the etchant. If the viscosity is smaller than the lower limit value, the viscosity of the etchant is too low and the etchant dropped on the other side of a wafer will be rapidly blown out of the wafer surface by centrifugal force and can not have enough and uniform contact with the other side of a wafer so that it may take longer time to ensure removal amount, which may result in lower productivity. On the other hand, if the viscosity is greater than the upper limit value, the etchant dropped on the other side of a wafer remains on the wafer surface longer time than needed and it may be difficult to control shape of the surface as well as the periphery of the wafer, which may result in deterioration of flatness of the wafer. If the surface tension is smaller than the lower limit value, the etchant dropped on the other side of a wafer will be rapidly blown out of the wafer surface by centrifugal force and can not have enough and uniform contact with the other side of a wafer so that it may take longer time to ensure removal amount, which may result in lower productivity. On the other hand, if the surface tension is greater than the upper limit value, the etchant dropped on the other side of a wafer remains on the wafer surface longer time than needed and it may be difficult to control shape of the surface as well as the periphery of the wafer, which may result in deterioration of flatness of the wafer. Another preferable mixture ratio of hydrofluoric acid, nitric acid, phosphoric acid and water in the etchant is 5-20%:20-40%:20-40%:20-40%. This mixture ratio will give viscosity of 10-25 mPa·sec and surface tension of 55-60 dyne/cm to the etchant. Preferable supply amount from nozzle 37 is 2-30 litter/min. Especially supply amount of acid etchant of 5-30 litter/min for a 300 mm silicon wafer and 3-20 litter/min for a 200 mm silicon wafer are respectively preferable.

Rotation speed of wafer 21 at smoothing step 15 is normally in the range of 100-2,000 rpm. The most suitable rotation speed somewhat varies depending on the diameter of wafer 21, viscosity of the etchant, supply position of etchant due to horizontal movement of nozzle 37 and flow rate of supplied etchant. If the speed of rotation is smaller than the lower limit value, it may be difficult to control shape of the surface as well as the periphery of the wafer, which may result in deterioration of flatness of the wafer, and if the speed of rotation is greater than the upper limit value, the etchant dropped on the other side of a wafer will be rapidly blown out of the wafer surface by centrifugal force and can not have enough and uniform contact with the other side of a wafer so that it may take longer time to ensure removal amount, which may result in lower productivity. For a 300 mm silicon wafer the rotation speed of 200-1500 rpm is preferable, especially 600 rpm is more preferable. For a 200 mm silicon wafer the rotation speed of 300-2000 rpm is preferable, especially 800 rpm is more preferable.

After etching process for the other side of wafer 21 the remaining etchant on the other side of wafer 21 is rinsed by spinning wafer 21 while rinsing liquid like deionized water is supplied from rinsing liquid supply nozzle (not shown) to the other side of wafer 21. At the end of rinsing step supply of rinsing liquid is ceased and wafer 21 is then dried by spinning wafer 21 while supplying inert gas like nitrogen gas to the wafer.

Removal amount by etching at smoothing step 15 is preferably 8-75 μm. The flatness and parallelism of the other side of the wafer can be improved by keeping the removal amount by etching in the range described above. Also when the other side is mirror-polished after smoothing step 15, polishing amount in this polishing step can be remarkably reduced comparing to conventional process for manufacturing wafer. If the removal amount by etching is smaller than the lower limit value, flatness and parallelism of the other side of wafer necessary for finished product will not be obtained and surface roughness will not be enough reduced, on the other hand, if the removal amount by etching is greater than the upper limit value, flatness of the wafer will be deteriorated and will result in lower productivity in wafer production.

In reference to FIG. 1 after single-side grinding step 14 and smoothing step 15 one side and the other side of the wafer are polished simultaneously (step 16).

A double-side polishing device commercially available can be used in double-side polishing step 16. Removal amount at double-side polishing step 16 is preferably less than 12 μm in total for both sides, and is more preferably 4-10 μm in total for both sides.

Because a wafer after single-side grinding step 14 and smoothing step 15 previously mentioned maintains flatness of wafer after flattening step like double-side grinding and also has desired roughness of surface, removal amount for both sides of wafer at double-side polishing step 16 can be reduced than at conventional process, which may result in reduction of production cost together with attainment of both maintaining flatness just after flattening step and reduction of roughness of wafer surface at the same time.

After double-side polishing step 16 only the other side of wafer is polished (step 17). A single-side polishing device commercially available can be used at single-side polishing step 17. Removal amount for the other side of wafer at single-side polishing step 17 is preferably 0.1-1 μm.

By processing at aforementioned process steps a silicon wafer, which has high flatness and is removed of damage by machine work and whose change of chamfer profile is reduced to be minimal can be obtained.

In embodiments of the present invention one side of a wafer is preferably the backside of the wafer and the other side is preferably the front side of the wafer.

Assuming the total removal amount at double-side grinding step 13, single-side grinding step 14 and double-side polishing step 16 to 100%, it is preferable to control the removal amount at each step to 40-60% at double-side grinding step, 25-40% at single-side grinding step and 10-25% at double-side polishing step, considering shaping capability at each step and mechanical damage introduced at the previous step. It is especially preferable to control the removal amount at each step to 50% at double-side grinding step, 30% at single-side grinding step and 20% at double-side polishing step.

### EXAMPLE

Next, Examples according to the present invention are explained together with Comparative Examples.

### Example 1

A silicon single crystal ingot with diameter of 300 mm is prepared and the ingot is sliced to get a plurality of sliced wafers. The sliced wafers are chamfered at their peripheries. Then one side and the other side of the wafer are ground simultaneously using a grinding device (not shown). Removal amount at this double-side grinding step is 15 μm for one side and 15 μm for the other side of the wafer, 30 μm in total for both sides. Then only one side of the wafer is ground using a grinding device shown in FIGS. 3 and 4. Removal amount for that side at this single-side grinding step is set to 10 μm.

Then the other side of the wafer is etched using single disk wafer etching device shown in FIG. 5. Mixture ratio of hydrofluoric acid, nitric acid, phosphoric acid and water for the etchant is hydrofluoric acid:nitric acid:phosphoric acid:water=10%:30%:30% 30%. Rotation speed of the wafer is controlled to 600 rpm, flow rate of the etchant to 5 liter/min and etching time to 20 sec. Removal amount at wafer etching is set to 10 μm. After the etching process the wafer is rinsed by supplying deionized water to the surface of the wafer and is then dried by blowing nitrogen gas to the surface of the wafer.

Then one side and the other side of the wafer are simultaneously polished. Removal amount in total for both sides at this double-side polishing step is varied in the range of 4-15 μm. After that only the other side of the wafer is polished. Removal amount for the other side of the wafer at this single-polishing step is set to 0.5 μm. A plurality of silicon wafers has been prepared according to above process.

### Comparative Example 1

A silicon single crystal ingot with diameter of 300 mm is prepared and the ingot is sliced to get a plurality of sliced wafers. The sliced wafers are chamfered at their peripheries. Then one side and the other side of the wafer are ground simultaneously using a grinding device (not shown). Removal amount at this double-side grinding step is 15 μm for one side and 15 μm for the other side of the wafer, 30 μm in total for both sides. Then one side and the other side of the wafer are ground in order using a grinding device shown in FIGS. 3 and 4. Removal amount for each side at this single-side grinding step is 10 μm, making 20 μm in total.

Then one side and the other side of the wafer are simultaneously polished. Removal amount in total for both sides at this double-side polishing step is varied in the range of 4-15 μm. After that only the other side of the wafer is polished. Removal amount for the other side of the wafer at this single-polishing step is set to 0.5 μm. A plurality of silicon wafers has been prepared according to above process.

### Comparative Test 1

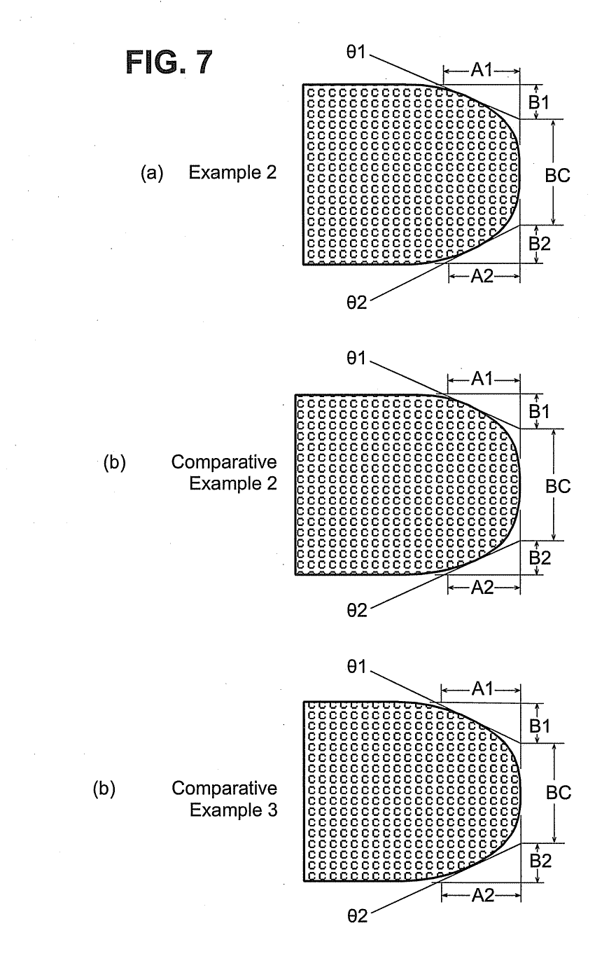

Particles greater than 50 nm on the surface of a plurality of wafers obtained in the Example 1 and the Comparative Example 1 are measured with a particle measuring device (SP1 by KLA-Tencor Co.). The relationship between LPD (Light Point Defect) count for particles greater than 50 nm and total removal amount for both sides at the double-side polishing step is shown in FIG. 6.

It is evident from FIG. 6 that almost no LPD count exists for the total removal amount for both sides of around 14 μm, while for the total removal amount for both sides less than 12 μm LPD count in Example 1 is smaller than that in the Comparative Example 1 in spite of smaller total removal amount at double-side polishing step.

### Example 2

A silicon single crystal ingot with diameter of 300 mm is prepared and the ingot is sliced to get sliced wafers. The sliced wafers are chamfered at their peripheries. Then both sides of the wafer are ground simultaneously using a grinding device (not shown). Removal amount at this double-side grinding step is 15 μm for one side and 15 μm for the other side, 30 μm in total for both sides. Then only one side of the wafer is ground using a grinding device shown in FIGS. 3 and 4. Removal amount for that side of the wafer at this single-side grinding step is 10 μm.

Then the other side of the wafer is etched using a single disk wafer etching device shown in FIG. 5. Mixture ratio of hydrofluoric acid, nitric acid, phosphoric acid and water for the etchant is hydrofluoric acid:nitric acid:phosphoric acid:water=10%:30%:30%:30%. Rotation speed of the wafer is controlled to 600 rpm, flow rate of the etchant to 5 litter/min and etching time to 20 sec. Removal amount at wafer etching is set to 10 μm. After the etching process the wafer is rinsed while being spun and supplied with deionized water to the surface and is then dried by blowing nitrogen gas to the surface of the wafer.

Then one side and the other side of the wafer are simultaneously polished. Removal amount in total for both sides at this double-side polishing step is set to 12 μm. After that only the other side of the wafer is polished. Removal amount for the other side of the wafer at this single-polishing step is set to 0.5 μm. A plurality of silicon wafers has been prepared according to above process.

### Comparative Example 2

A silicon single crystal ingot with diameter of 300 mm is prepared and the ingot is sliced to get sliced wafers. The sliced wafers are chamfered at their peripheries. Then one side and the other side of the wafer are ground simultaneously using a grinding device (not shown). Removal amount at this double-side grinding step is 15 μm for one side and 15 μm for the other side of the wafer and 30 μm in total for both sides. Then both sides of the wafer are ground in order using a grinding device shown in FIGS. 3 and 4. Removal amount for each side at this single-side grinding step is 10 μm, making 20 μm in total.

Then one side and the other side of the wafer are simultaneously polished. Removal amount in total for both sides at this double-side polishing step is set to 12 μm. After that only the other side of the wafer is polished. Removal amount for the other side of the wafer at this single-polishing step is set to 0.5 μm. A plurality of silicon wafers has been prepared according to above process.

### Comparative Example 3

A silicon single crystal ingot with diameter of 300 mm is prepared and the ingot is sliced to get sliced wafers. The sliced wafers are chamfered at their peripheries. Then one side and the other side of the wafer are ground simultaneously using a grinding device (not shown). Removal amount at this double-side grinding step is 15 μm for one side and 15 μm for the other side of the wafer, 30 μm in total for both sides.

Then the other side of the wafer is etched as smoothing step using a single disk wafer etching device shown in FIG. 5. Mixture ratio of hydrofluoric acid, nitric acid, phosphoric acid and water for the acid etchant is hydrofluoric acid:nitric acid:phosphoric acid:water=10%:30% 30%:30%. Rotation speed of the wafer and flow rate of the etchant are controlled to 600 rpm and 5 litter/min, respectively and etching time is 20 sec. Removal amount at wafer etching is set to 10 μm. After the etching process the wafer is rinsed while being spun and supplied with deionized water to the surface and is then dried by blowing nitrogen gas to the surface of the wafer. Then the wafer is turned upside down and the other side is etched under the same conditions with the removal amount of 10 μm.

Then one side and the other side of the wafer are simultaneously polished. Removal amount for both sides in total at this double-side polishing step is set to 12 μm. After that only the other side of the wafer is polished. Removal amount for the other side of the wafer at this single-polishing step is set to 0.5 μm. A plurality of silicon wafers has been prepared according to above process.

### Comparative Test 2

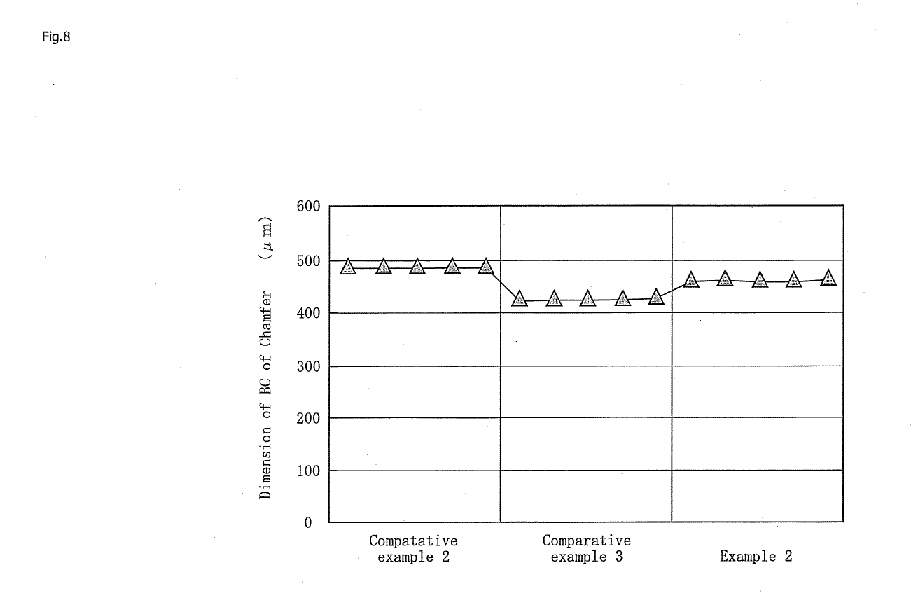

Chamfers of wafers derived in Example 2, Comparative Examples 2 and 3 are measured with a measuring device for chamfer profile (Edge Profiler by Kobelco Kaken Co.). The measured result is shown in FIG. 7 and dimension of BC of measured chamfer is shown in FIG. 8.

It is evident from FIG. 7 that no large deterioration of profile with all chamfers in Example 2 as well as in Comparative Examples 2 and 3 can be observed. The profile of chamfer in Example 2 has no so much difference with that in Comparative Example 2 and the result is similar to that in conventional process. On the other hand, the dimension of BC at the chamfer of Comparative Example 3 is smaller comparing to those of other wafers. The reason that the dimension of BC in Comparative Example 3 has been reduced may be considered that the frequency of wraparound of etchant to the chamfer is relatively high at each single disk wafer etching step for one side as well as for the other side, respectively.

### Comparative Test 3

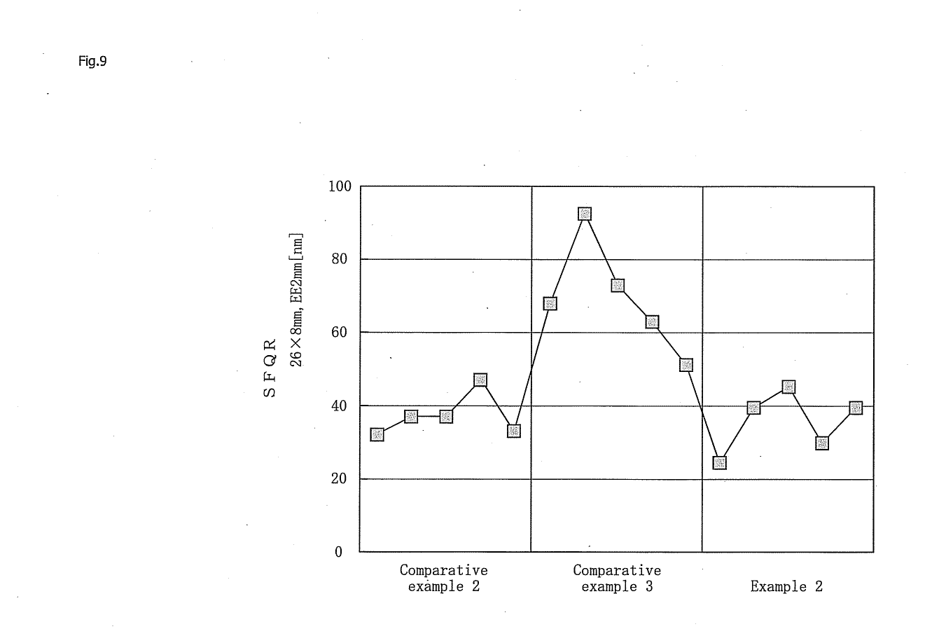

Flatness (SFQR: Site Front Least Squares Range) of wafers obtained in Example 2 and Comparative Examples 2 and 3 is measured using a flatness measuring device (Wafercom, by Doi Seimitsu-Rap Co.). The result is shown in FIG. 9.

It can be easily seen in FIG. 9 that SFQR of Example 2 and Comparative Example 2 remain in the range of 30-40 μm and flatness obtained in Example 2 is similar to that obtained in conventional process. On the other hand, SFQR of Comparative Example 3 stays in generally high range of 50-90 μm. The reason may be considered that both sides of the wafer of Comparative Example 3 are etched. In order to use the process of Comparative Example 3 for input material with dispersed thickness, for example, some technique such as pre-measured thickness is reflected to working condition will be needed and this may make the process more complicated.

What is claimed is:

1. A method for manufacturing a silicon wafer comprising the steps of; slicing a silicon single crystal ingot to obtain sliced wafers; single-side grinding only one side of the sliced wafer; and smoothing the other side of the sliced wafer by controlling the application of etchant depending on the surface shape of the other side of the wafer.

2. The method according to claim 1, wherein the single-side grinding step and the smoothing step are performed in this order.

3. The method according to claim 1, wherein the smoothing step and the single-side grinding step are performed in this order.

4. The method according to claim 1, wherein the periphery of one side of the wafer and the periphery of the other side of the wafer are chamfered before the single-side grinding step or the smoothing step.

5. The method according to claim 2 wherein the periphery of one side of the wafer and periphery of the other side of the wafer are chamfered before the single-side grinding step or the smoothing step.

6. The method according to claim 3 wherein the periphery of one side of the wafer and periphery of the other side of the wafer are chamfered before the single-side grinding step or the smoothing step.

7. The method according to claim 1 further including a double-side grinding step to grind one side and the other side of the wafer simultaneously before the single-side grinding step and the smoothing step.

8. The method according to claim 2 further including a double-side grinding step to grind one side and the other side of the wafer simultaneously before the single-side grinding step and the smoothing step.

9. The method according to claim 2 further including a double-side grinding step to grind one side and the other side of the wafer simultaneously before the single-side grinding step and the smoothing step.

10. The method according to claim 1, further including a lapping step to lap one side and the other side of the wafer simultaneously before the single-side grinding step and the smoothing step.

11. The method according to claim 2, further including a lapping step to lap one side and the other side of the wafer simultaneously before the single-side grinding step and the smoothing step.

12. The method according to claim 2, further including a lapping step to lap one side and the other side of the wafer simultaneously before the single-side grinding step and the smoothing step.

13. The method according to claim 1, further including a polishing step where one side and the other side of the wafer are simultaneously polished after the single-side grinding step or the smoothing step.

14. The method according to claim 2, further including a polishing step where one side and the other side of the wafer are simultaneously polished after the smoothing step.

15. The method according to claim 3, further including a polishing step where one side and the other side of the wafer are simultaneously polished after the single-side grinding step.

16. The method according claim 13, wherein removal amount at a simultaneous polishing step for one side and the other side of the wafer is less than 12 μm in total for both sides.

17. The method according claim 14, wherein removal amount at a simultaneous polishing step for one side and the other side of the wafer is less than 12 μm in total for both sides.

18. The method according claim 15, wherein removal amount at a simultaneous polishing step for one side and the other side of the wafer is less than 12 μm in total for both sides.

19. The method according to f claim 13, further including a single-side polishing step for the other side of the wafer after simultaneous polishing step for one side and the other side of the wafer.

20. The method according to claim 14, further including a single-side polishing step for the other side of the wafer after simultaneous polishing step for one side and the other side of the wafer.

21. The method according to claim 15, further including a single-side polishing step for the other side of the wafer after simultaneous polishing step for one side and the other side of the wafer.

22. The method according to claim 1, wherein one side of the wafer is the backside of the wafer and the other side of the wafer is the front side of the wafer.

23. A wafer obtained by the method of claim 1.
